(19) United States
(12) Patent Application Publication
(10) Pub. No.: US 2025/0007036 A1
(43) Pub. Date: Jan. 2, 2025

(54) INTER-CELL COOLING UNIT FOR A BATTERY MODULE AND BATTERY MODULE FOR A MOTOR VEHICLE

(71) Applicant: AUDI AG, Ingolstadt (DE)

(72) Inventors: Uwe GERLINGER, Kipfenberg (DE); Carsten LORENZ, Reichertshofen (DE); Eduard MAIN, Buxheim (DE)

(73) Assignee: AUDI AG, Ingolstadt (DE)

(21) Appl. No.: 18/734,314

(22) Filed: Jun. 5, 2024

(30) Foreign Application Priority Data
Jun. 29, 2023 (DE) 10 2023 117 134.8

(51) Int. Cl. H01M 10/6557; H01M 10/613; H01M 10/625; H01M 10/6568

(52) U.S. Cl. CPC H01M 10/6557; H01M 10/613; H01M 10/625; H01M 10/6568

(57) ABSTRACT

An inter-cell cooling unit for arrangement a battery module for arrangement in an intermediate space between twin an intermediate space between two battery cells of a cell stack which are arranged adjacent to one another in a stacking direction. The inter-cell cooling unit has two cooling walls including a first cooling wall for arrangement on a first of the two battery cells and a second cooling wall for arrangement on a second of the two battery cells. At least one free space through which a coolant can flow is formed between the first and second cooling walls. At least one first opening is arranged in at least one of the two cooling walls, through which first opening a fluidic connection is provided between the at least one free space and an environment of the inter-cell cooling unit.

### FIELD

The invention relates to an inter-cell cooling unit for a battery module for arrangement in an intermediate space between two battery cells of a cell stack arranged adjacent to one another in a stacking direction, wherein the inter-cell cooling unit has two cooling walls comprising a first cooling wall for arrangement on a first of the two battery cells and a second cooling wall for arrangement on a second of the two battery cells, wherein at least one free space through which a coolant can flow is formed between the first and second cooling walls. Furthermore, the invention also relates to a battery module for a motor vehicle.

### BACKGROUND

Battery cells of battery modules can be cooled during operation by means of a cooling device. Often, cooling plates are used through which a coolant can flow and on which the battery modules, for example a high-voltage battery for a motor vehicle, are arranged. In this way, only a small region of the respective battery cells of a battery module can be cooled. The sides of a battery cell with the largest region are typically those that face the neighboring cell in a cell stack in or against the stacking direction. An inter-cell cooling unit, i.e. an element that can be arranged between two cells of such a cell stack, can provide even more efficient cooling of the battery cells.

Nevertheless, it is still desirable to further increase the cooling efficiency for cooling such battery cells in a battery module, especially for high-voltage batteries.

DE 10 2021 114 360 A1 describes an energy storage device with a battery cell stack made up of a plurality of stack-like storage cells arranged next to one another and a cooling device which has at least one thermally conductive element which is arranged between two adjacent storage cells and which extends from the intermediate region between the two storage cells to a coolant line and is thermally contacted with the coolant line.

Furthermore, US 2001/0007728 A1 describes a battery pack with prismatic cells arranged parallel to each other and with cooling channels formed by structured spacer plates made of metallic material located between the cells.

### SUMMARY

The object of the present invention is to provide an inter-cell cooling unit and a battery module which allow the most efficient cooling of battery cells possible.

An inter-cell cooling unit according to the invention for arrangement in an intermediate space between two battery cells of a cell stack arranged adjacent to one another in a stacking direction has two cooling walls comprising a first cooling wall for arrangement on a first of the two battery cells and a second cooling wall for arrangement on a second of the two battery cells, wherein at least one free space through which a coolant can flow is formed between the first and second cooling walls. In this case, at least one first opening is arranged in at least one of the second cooling walls, through which first opening a fluidic connection is provided between the at least one free space and an environment of the inter-cell cooling unit.

Such an opening advantageously makes it possible for a coolant which flows through the at least one free space between the two cooling walls to be brought into direct contact with a cell wall of the battery cell adjacent to the corresponding cooling wall through this first opening, when the inter-cell cooling unit is arranged as intended between the two battery cells. This advantageously allows the cooling efficiency to be increased even further, since the battery cells adjacent to the inter-cell cooling unit can be at least partially in direct contact with the coolant that flows through the inter-cell cooling unit during operation. This allows the battery cells to be advantageously connected directly to the cooling medium or coolant that flows through the cooling plates between the cells, namely the corresponding inter-cell cooling unit.

At the same time, the inter-cell cooling unit can be used to counteract swelling pressure of the battery cells, which results from expansion of the battery cells, for example over the course of their service life and/or when charging the battery cells. The inter-cell cooling unit can thus simultaneously act as a spacer between the battery cells and be used for swelling compensation. This saves additional components.

The inter-cell cooling unit is preferably used in a battery module which has a cell stack with battery cells which are designed as prismatic battery cells or pouch cells.

The inter-cell cooling unit can also have a base element which defines the part of the inter-cell cooling unit which, when the inter-cell cooling unit is arranged as intended between two battery cells, is located within the space between the two battery cells arranged adjacent to one another in the stacking direction. In addition to this base element, the inter-cell cooling unit can optionally also have at least one further component or at least one portion that protrudes from the space between the two battery cells, in particular perpendicular to the stacking direction. However, the inter-cell cooling unit can also be limited to the base element, i.e. arranged entirely within this space between two battery cells.

The dimensions of the cooling walls, in particular a length and/or width of these cooling walls perpendicular to the stacking direction, can correspond to the length and width of the cell sides of the battery cells adjacent to the respective cooling walls. This is particularly advantageous because it allows the contact region between the battery cell and the inter-cell cooling unit to be maximized. The two cooling walls can, for example, be arranged substantially parallel to each other and be substantially flat. Furthermore, the cooling walls are preferably spaced apart from one another, in particular in the stacking direction, when the inter-cell cooling unit is arranged as intended between two battery cells, whereby the at least one free space can be provided. The cooling walls can basically be made of any material, especially the inter-cell cooling unit as a whole. Metallic materials, such as aluminum, are particularly suitable for cooling walls due to their high thermal conductivity. However, non-metallic materials such as plastic can also be used to form the cooling walls. Material combinations are also conceivable. In other words, the individual elements of the inter-cell cooling unit, for example the first cooling wall and the second cooling wall, can be made of different materials, for example one cooling wall made of aluminum and the other of plastic.

The at least one first opening represents a breakthrough in at least one of the two cooling walls. The opening is therefore provided by a hole in the corresponding cooling wall. A part of the environment of the inter-cell cooling unit can be provided by at least one of the battery cells, for example when the inter-cell cooling unit is arranged as intended between the two battery cells. The opening in at least one of the cooling walls can also be closed by a cell wall of one of the battery cells if the inter-cell cooling unit is arranged as intended between the two battery cells.

Such a hole or the at least one first opening can in principle have any geometry, for example round, in particular circular or elliptical, elongated, angular, for example triangular, square, pentagonal, and so on. Furthermore, it is preferred that not only one such opening is provided in the cooling wall in question, but several, in particular numerous openings. This will be explained in more detail later. The openings can then differ from one another in terms of their size and/or geometry, or they can all be of the same design.

In a further advantageous embodiment of the invention, the at least one first opening is arranged in the first cooling wall and at least one second opening is arranged in the second cooling wall, through which second opening a respective fluidic connection is provided between the at least one free space and an environment of the inter-cell cooling unit. Through this second opening, it is therefore possible to more efficiently cool the other of the two battery cells, which is adjacent to the second cooling wall when the inter-cell cooling unit is arranged in the cell stack as intended, since direct contact can now also be established through this second opening between this second battery cell, which is adjacent to the second cooling wall, and the cooling medium flowing through the inter-cell cooling unit.

As explained in more detail later, there can be not only one free space between the two cooling walls, but also several free spaces, which will later also be referred to as partial free spaces. These can be fluidically connected to each other or fluidically separated from each other and form separate cooling channels between the two cooling walls. The first opening in the first cooling wall can, for example, fluidly connect the interior of a first such cooling channel with the environment of the inter-cell cooling unit and the second opening can connect the interior of a second cooling channel of the inter-cell cooling unit with the environment of the inter-cell cooling unit. In other words, the first and second openings do not necessarily have to establish a fluidic connection between the environment of the inter-cell cooling unit and the same free space within the inter-cell cooling unit. Nevertheless, this is still possible.

The first opening can thus, for example, establish a fluidic connection between a first free space between the two cooling walls and an environment of the inter-cell cooling unit and the second opening can establish a fluidic connection between a second free space between the two cooling walls and an environment of the inter-cell cooling unit, wherein the two free spaces can be fluidically connected to one another or can be fluidically separated from one another, at least in the region of the inter-cell cooling unit, which is located in the space between the two battery cells.

In a further advantageous embodiment of the invention, the inter-cell cooling unit has a structural element, in particular an intermediate wall with a corrugated structure, which is arranged between the first and the second cooling wall and which divides the free space between the first and the second cooling wall into several partial free spaces. As already described above, these partial free spaces can be fluidically connected to each other or completely separated from each other. This depends on the design of the structural element, as will be explained in more detail later. The provision of such a structural element has the great advantage that the two cooling walls can be kept at a defined distance from each other. The swelling forces mentioned above therefore do not result in the inter-cell cooling unit being completely flattened. The structural element can therefore ensure the flow through the inter-cell cooling unit even under the influence of swelling forces from the cells on both sides of the cooling walls. It is furthermore particularly advantageous if this structural element is provided as an intermediate wall with a corrugated structure. For example, such an intermediate wall can be made of corrugated metal sheet. Such a corrugated structure has corresponding maxima and minima, wherein, for example, the maxima of the corrugated structure of the intermediate wall can rest on the first cooling wall or can contact it if the minima contact the second cooling wall accordingly. Such a corrugated structure has the great advantage that a kind of spring support can be provided between the two cooling walls. In this way, the swelling forces described can be absorbed particularly efficiently. By providing such an intermediate wall with a corrugated structure between the two cooling walls, the free space between the two cooling walls is automatically divided into partial free spaces, which can provide corresponding cooling channels through the inter-cell cooling unit. This enables a defined flow through the inter-cell cooling unit. This intermediate wall can also be made of any material, for example metal or plastic. Here, too, it is conceivable that the individual parts of the inter-cell cooling unit, in particular the two cooling walls and the intermediate wall, are made of different materials. For example, the intermediate wall can be made of a plastic and the two cooling walls can be made of a metallic material or vice versa, the two cooling walls can be made of a plastic and the intermediate wall can be made of a metal.

The intermediate wall and the two adjacent cooling walls can be firmly connected to each other, namely joined to each other. For example, the cooling walls and the intermediate wall, particularly depending on the material, can be welded together, glued together or joined using another joining method.

According to a first variant, the intermediate wall can be designed to be fluid-tight. This means that the intermediate wall has no openings or other regions through which a fluid, in particular the coolant, such as water, can penetrate. As a result, the respective partial free spaces are separated from each other in a fluid-tight manner.

According to a further embodiment of the invention, the intermediate wall has at least one third opening through which at least two of the partial free spaces are fluidically connected to one another. Such a third opening advantageously enables mixing of the fluid flowing through the respective cooling channels. This allows, for example, better homogenization of the coolant temperature. Here, too, it is conceivable that the intermediate wall does not only have such a third opening, but a hole pattern with numerous third openings. This can be designed as a regular hole pattern or an irregular hole pattern.

The same applies to the cooling walls, as will be explained in more detail below.

Accordingly, it represents a further very advantageous embodiment of the invention if a hole pattern comprising the first opening and having numerous first openings is arranged at least in the first cooling wall. Preferably, this also applies to the second cooling wall. In other words, it is preferred that a second hole pattern comprising the second opening and having numerous second openings is also arranged in the second cooling wall. The descriptions of the hole pattern in the first cooling wall can also apply to the hole pattern in the second cooling wall.

Such a hole pattern with numerous first openings has the great advantage, for example in contrast to a single large opening, that a particularly large contact region can be provided between the coolant flowing through the inter-cell cooling unit and the adjacent cell walls of the battery cells, and at the same time a high mechanical stability of the inter-cell cooling unit can be provided. This also allows for more efficient support of the intermediate wall between the two cooling walls. This then does not come into contact with the cell sides of the battery cells adjacent to the cooling walls. Local pressure loads on the cells caused by the corrugated pattern of this intermediate wall can thus be avoided. The cooling walls can then ensure a particularly even pressure distribution of the swelling forces on the battery cells, despite the perforations.

In order to enable an even more uniform or adapted pressure distribution, it is also conceivable that the intermediate wall with the corrugated structure is designed in such a way that the intermediate wall has a corrugated structure with different wavelengths in different regions. In other words, the distances between adjacent maxima of this corrugated structure can be larger in a first region of the intermediate wall than in a second region of the intermediate wall. For example, the corrugated structure can be formed in a central region with respect to a length and width perpendicular to the stacking direction with a smaller wavelength than in an peripheral region, or vice versa.

In a further very advantageous embodiment of the invention, the first openings of the first hole pattern are geometrically identical, in particular with regard to their shape and size, in particular wherein the hole pattern is formed as a regular pattern. The hole pattern therefore has a pattern unit that repeats itself, in particular repeats itself periodically. This enables particularly uniform cooling of the adjacent cell sides and simple formation and design of the hole pattern.

However, it is also conceivable to design the individual holes of the hole pattern differently or to arrange them differently in relation to one another. This advantageously makes it possible to cool in a targeted manner specific regions of the adjacent battery cells more or less strongly and/or to provide adaptations to the different swelling forces of the cells in the central region and in the peripheral region.

Therefore, it represents a further advantageous embodiment of the invention if the hole pattern comprises at least two first openings which differ in size, one of which is arranged in an peripheral region of the first cooling wall and the other in a central region of the cooling wall, and/or one of which is arranged in a hotspot region of the battery cell adjacent to the first cooling wall when the inter-cell cooling unit is arranged as intended between the two battery cells, and the other is arranged in a cell region which is different from this hotspot region.

A hotspot region of a battery cell represents a region of the battery cell in which the battery cell heats up the most, at least locally, at least during operation or, for example, when charging. Such a hotspot region therefore has a local temperature maximum of the cell during operation or when charging the cell. A cell can also have multiple hotspot regions. These are often located near the cell poles.

The design of the hole pattern with openings of different sizes now advantageously allows, for example, larger openings to be provided in the region of such hotspot regions. This allows the adjacent cells in these hotspot regions to be cooled more effectively, in a targeted manner. This allows a more homogeneous temperature distribution across the cell to be achieved.

Openings of different sizes can also be used advantageously to provide different levels of resistance to the swelling forces. For example, in the peripheral region of the cell, the adjacent openings may be smaller than in the central region, or vice versa.

Furthermore, the invention also relates to a battery module for a motor vehicle which comprises a cell stack with at least two battery cells arranged adjacent to one another in a stacking direction, as well as an inter-cell cooling unit according to the invention or one of its embodiments, which are arranged between the two battery cells.

The advantages mentioned for the inter-cell cooling unit according to the invention and its embodiments thus apply similarly to the battery module according to the invention.

The battery cells can be formed as lithium-ion cells, for example. In addition, the descriptions of the battery module, as already explained in connection with the inter-cell cooling unit, should also be valid for the battery module according to the invention and its embodiments.

Conversely, the following descriptions relating to the inter-cell cooling unit are also intended to provide further corresponding, optional developments of the inter-cell cooling unit described above.

The battery module can generally have not only two battery cells, but numerous battery cells provided in the form of a cell stack. A corresponding inter-cell cooling unit can be arranged between every two battery cells arranged adjacent to each other in the stacking direction. Each of these inter-cell cooling units can be designed as an inter-cell cooling unit according to the invention or one of its embodiments. The inter-cell cooling units can also be designed as different embodiments.

In a further advantageous embodiment of the invention, respective cooling channels are provided by the partial free spaces, which run from a respective channel inlet to a respective channel outlet, wherein the inter-cell cooling unit has a first connection element, for example a nozzle, which is connected to the respective channel inlets and via which a coolant can be supplied to the inter-cell cooling unit, and a second connection element which is connected to the channel outlets and via which the coolant can be discharged from the inter-cell cooling unit. Furthermore, in this case it is preferred that the region of the first cooling wall which comprises the at least one first opening, in particular the hole pattern, is arranged on the first battery cell on which the first cooling wall is arranged, in a sealing manner relative to the latter by means of a seal which runs around the region of the first cooling wall. Despite the hole pattern, it can be ensured that no coolant can leak out. The seal can be arranged all around the peripheral region of the cell side of the first battery cell. The seal is then located accordingly, for example as a sealing contour, between this cell side of the first battery cell and the first cooling wall. The same applies to the second battery cell and the second cooling wall.

In a further advantageous embodiment of the invention, the battery module has a cooling device which comprises the inter-cell cooling unit, wherein the inlets and outlets of the respective cooling channels are fluidically connected to an environment of the battery module, wherein the cooling device is designed such that the battery cells are at least partially in contact with a coolant located outside the inter-cell cooling unit during operation of the cooling device.

In this case, cooling is provided as an open flow cooling. In other words, in this case the coolant can come into direct contact with the battery cells, not only through the openings in the cooling walls, but also in regions outside the inter-cell cooling units. For this purpose, the cell stack can be arranged in a receptacle which is designed to be fluid-tight so that the preferably liquid coolant cannot leak out. For example, if the entire cell stack is located within this receptacle or has coolant flowing around it, an electrically non-conductive coolant, for example an oil, can be used as the coolant. A gas, although less preferred, can also be used as a coolant. However, it can also be the case that only a part of the battery cells is arranged in the receptacle or a part of a respective battery cell included in the cell stack, wherein this part of the battery cell arranged in the receptacle does not represent the part on which the cell poles are arranged. In other words, the cell housings can also be designed to be electrically insulated from the outside and the cell poles can be positioned outside the receptacle through which the coolant flows. In this case, an electrically conductive coolant, for example water or water with additives or another water-based coolant, can also be used.

The invention also includes developments of the battery module according to the invention, which have the same features which have already been described in conjunction with the developments of the inter-cell cooling unit according to the invention. For this reason, the corresponding developments of the battery module according to the invention are not described again here.

Furthermore, the invention also relates to a high-voltage battery for a motor vehicle, which battery has at least one battery module according to the invention or one of its embodiments. The high-voltage battery can also have multiple of such battery modules. The invention also comprises a motor vehicle having a battery module according to the invention or one of its embodiments.

The motor vehicle according to the invention is preferably designed as an automobile, in particular as a passenger car or truck, or as a passenger bus or motorcycle.

The invention also comprises the combinations of the features of the described embodiments. The invention therefore also includes implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic representation of at least a part of an inter-cell cooling unit for a battery module according to an exemplary embodiment of the invention;

FIG. 2 shows a schematic representation of an inter-cell cooling unit according to a further exemplary embodiment of the invention.

FIG. 3 shows a schematic representation of an inter-cell cooling unit according to a further exemplary embodiment of the invention.

FIG. 4 shows a schematic representation of a plan view on an inter-cell cooling unit having a hole pattern according to another exemplary embodiment of the invention;

FIG. 5 shows a schematic representation of a plan view on an inter-cell cooling unit having a hole pattern according to another exemplary embodiment of the invention;

FIG. 6 shows a schematic representation of a battery module in a plan view with an open flow cooling according to an exemplary embodiment of the invention; and

FIG. 7 shows a schematic representation of an inter-cell cooling unit with cooling connections according to a further exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

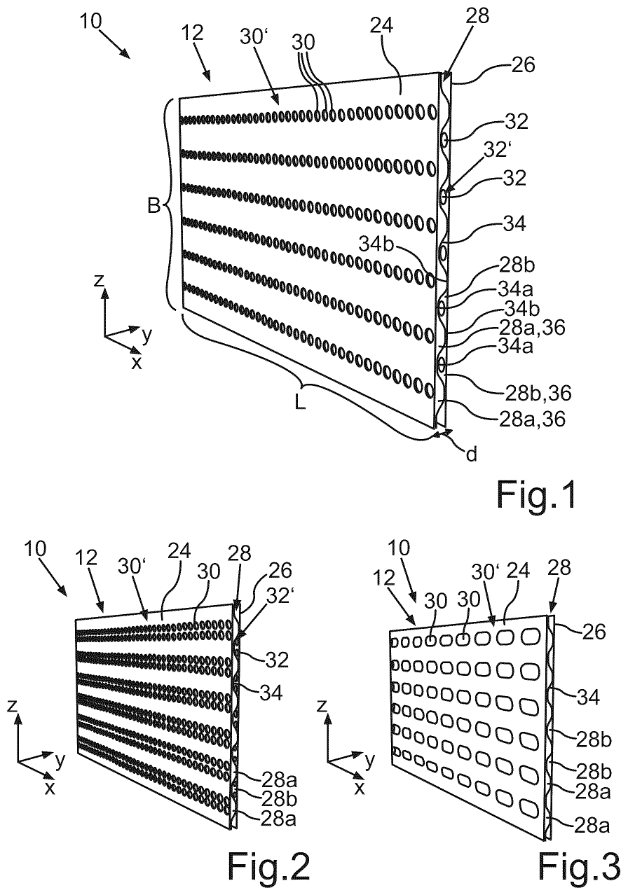

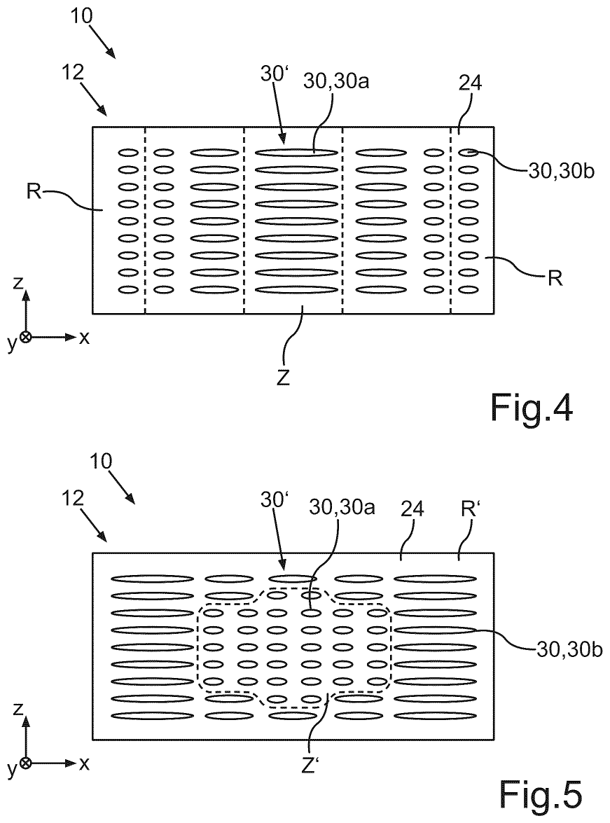

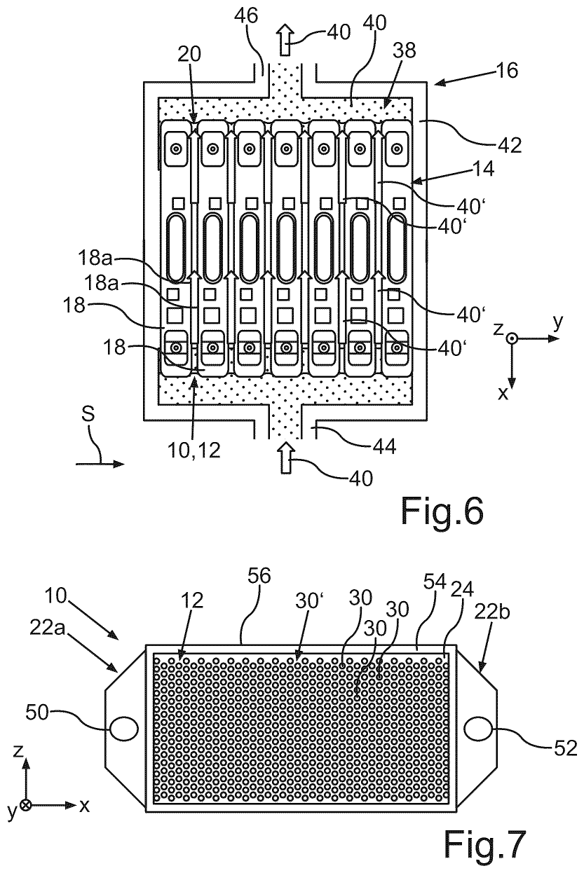

FIG. 1 shows a schematic representation of at least a part of an inter-cell cooling unit 10 according to an exemplary embodiment of the invention. The inter-cell cooling unit 10 or at least part thereof is shown in a perspective view. The inter-cell cooling unit 10 comprises a base element 12, which is shown in FIG. 1. With respect to a proper arrangement in a cell stack 14 of a battery module 16 with multiple battery cells 18 arranged adjacent to one another in a stacking direction S, this base element 12 is arranged within an intermediate space 20 between two battery cells 18 arranged adjacent to one another (see also FIG. 6). Optionally, the inter-cell cooling unit 10 can also comprise regions, for example connection regions 22a, 22b (cf. FIG. 7), which can then be located outside this intermediate space 20 between two battery cells 18. These optional connection regions 22a, 22b are not shown in FIG. 1, but can also be optionally provided for the described inter-cell cooling unit 10 and the inter-cell cooling units 10 explained in more detail below, of which only their base elements 12 are illustrated in FIG. 2, FIG. 3, FIG. 4 and FIG. 5.

The base element 12 of the inter-cell cooling unit 10 now has two cooling walls 24, 26. These cooling walls 24, 26 are spaced apart by a distance d in the illustrated y-direction, which corresponds to the stacking direction S when the inter-cell cooling unit 10 is arranged as intended in a cell stack 14. In addition, the cooling walls 24, 26 are essentially flat and parallel to each other. Preferably, the cooling walls 24, 26 are made of a metallic material, but can also be made of plastic or any other material. The distance d provides at least one free space 28 between the two cooling walls 24, 26 through which free space a coolant can flow. With respect to the intended arrangement of the inter-cell cooling unit 10 in a cell stack 14, the two cooling walls 24, 26 adjoin the cells 18 of such a cell stack 14, which are arranged adjacent to one another. In particular, these border on the cell sides designated 18a (cf. FIG. 6).

The cooling walls 24, 26 are now advantageously each formed with openings 30, 32. The openings 30 in the first cooling wall 24 may also be referred to as first openings 30, while the openings 32 in the second cooling wall 26 may also be referred to as second openings 32. For reasons of clarity, only some of these openings 30, 32 for each cooling wall 24, 26 are provided with a reference number. Through these openings 30, 32 it is now advantageously possible for the base element 12, in particular the coolant flowing through the free space 28, to be brought into direct contact with the cell sides 18a of the cells 18. This allows significantly more efficient cooling and heat dissipation to be provided.

Furthermore, the base element 12 also comprises an intermediate wall 34 with a corrugated structure. In the present example, the intermediate wall 34 is designed as corrugated metal sheet 34. The corrugated metal sheet 34 has maxima 34a and minima 34b according to a corrugated structure. The maxima 34a simultaneously represent contact regions or connection regions to the first cooling wall 24, while the minima 34b provide corresponding contact regions or connection regions to the second cooling wall 26. The intermediate wall 34 is thus joined to the first cooling wall 34 in the contact regions provided by the maxima 34a and to the second cooling wall 26 via the contact regions provided by the minima 34b. The joint can be provided by a welded connection or an adhesive connection. Other designs or joining options are also conceivable.

This selected intermediate wall 34 also divides the free space 28 between the cooling walls 24, 26 into individual partial free spaces 28a, 28b. For reasons of clarity, also only some of these are provided with a reference number. The partial free spaces designated 28a represent those which directly adjoin the first cooling wall 24, and the partial free spaces designated 28b represent those which directly adjoin the second cooling wall 26. If desired, the first partial free spaces 28 can also be fluidically connected to the second partial free spaces 28b by also forming the intermediate wall 34 with openings or a hole pattern or the like. This enables mixing of the fluid flow within the base element 12 of the inter-cell cooling unit.

In this example, the first openings 30 in the first cooling wall 24 and also the second openings 32 in the second cooling wall 26 are arranged according to a corresponding hole pattern 30′, 32′. These hole patterns 30′, 32′ are formed in this example as regular hole patterns. In addition, all openings 30, 32 in this example are the same size and have the same geometric shape. However, this does not necessarily have to be the case. Furthermore, in this example, the first openings 30 are arranged in a region of the first cooling wall 24 which is not in direct contact with the intermediate wall 34, but directly adjoins the first partial free spaces 28a. Accordingly, the second openings 32 are also arranged in the region of the second cooling wall 26, which directly adjoin the second partial free spaces 28b and are also not in direct contact with the intermediate wall 34. As a result, the coolant flowing through the cooling channels 36 provided by the respective partial free spaces 28a, 28b can particularly easily come into contact with the cell walls 18a of the adjacent battery cells 18. In other words, the openings 30, 32 are not covered by parts of the intermediate wall 34. Nevertheless, other embodiments are also conceivable here, as described in more detail below and illustrated, for example, in FIG. 7.

The length L of a respective cooling wall 24, 26 or of the base element 12, which in this example is defined in the x-direction, and the width B of the cooling walls 24, 26 or of the base element 12, which in this example is defined in the z-direction, can correspond to a length and width of the corresponding cell walls 18a of the adjacent cells 18. This allows particularly efficient cooling of the cells 18 to be provided across their entire cell sides 18a.

FIG. 2 shows a schematic representation of an inter-cell cooling unit 10, or at least a part thereof, namely its base element 12, according to a further exemplary embodiment of the invention. The base element 12 can be formed as in FIG. 1, except for the difference that the hole pattern 30′, 32′ in the respective cooling walls 24, 26 is somewhat different. In particular, the individual openings 30, 32 are designed to be somewhat smaller, in particular with regard to their diameter, and twice as many openings 30, 32 are provided for this purpose.

FIG. 3 shows a schematic representation of at least a part of an inter-cell cooling unit 10, namely of the base element 12 thereof, according to a further exemplary embodiment of the invention. This can also be designed as previously described, except for the difference that the first and second cooling wall 24, 26 now again have a slightly differently designed hole pattern 30′. The respective openings 30, 32 providing the hole pattern 30′, 32′ are not circular but oval. In this example, these have a length in the x-direction that is slightly larger than their respective width in the z-direction.

FIG. 4 shows a schematic representation of a base element 12 of an inter-cell cooling unit 10 in a plan view on the first cooling wall 24 according to a further exemplary embodiment of the invention. The following descriptions with reference to the first cooling wall 24 can also apply analogously to the second cooling wall 26, although this is not visible in the present illustration. This base element 12 can also be designed as described above, except for the difference that the respective cooling walls 24, 26 are now again designed with a slightly different hole pattern 30′. The first cooling wall 24 is shown as an example. The hole pattern of the second cooling wall 26 may, however, be the same or similar to the hole pattern 30′ of the first cooling wall 24.

In this example, the hole pattern 30′ is formed by openings 30, which are different in size and/or shape. The openings 30 in a central region of the base element 12 relative to the x-direction shown here are designated 30a and the openings 30 in a respective peripheral region R relative to the x-direction are designated 30b. In the present example, the openings 30a in the central region Z are larger and more elongated than the openings 30b in the peripheral region. In particular, the hole size of the holes 30 decreases from the central region Z to the respective peripheral regions R in and against the x-direction. However, the hole size and geometry of the individual holes 30 does not vary in the z-direction.

FIG. 5 shows a schematic representation of a base element 12 of an inter-cell cooling unit 10, according to a further exemplary embodiment of the invention. Here, too, another hole pattern 30 is to be illustrated, while in principle the base element 12 can be designed as previously described. In this example, a central region Z′ of the base element 12 is defined in relation both to the x-direction and the z-direction. Outside this central region Z, a peripheral region R′ of the base element 12 may be defined. In this example, the openings 30 in the central region Z′, which are again designated 30a, are smaller than the openings 30 in the peripheral region R′, wherein the openings 30 in the peripheral region are also designated 30b. The hole size of holes 30 can therefore also increase from a central region Z′ to a peripheral region R′. The variation of the hole geometry and size can vary in one direction, for example only in the x-direction or only in the z-direction, or in two directions, namely in the x-direction and in the z-direction.

In principle, any other arrangement and design of the corresponding hole pattern 30′ are also conceivable. The hole sizes of the holes 30 can, for example, be adapted to hotspot regions of the cells 18. Larger holes 30 can then be provided in the hotspot regions of the cell sides 18a in order to cool them more efficiently than other, cooler regions of the cell sides 18a. Due to the different hole sizes of the openings 30, a better adaptation to the swelling forces of cells 18 can also be provided, which forces are typically different in the peripheral regions of cells 18 and in particular are lower than in the central region of cells, which corresponds for example to the central regions Z, Z′ of the base element 12 defined here.

Via the number of holes, the hole pattern 30′ or the hole shape, the wetting degree of the cell surface 18a with the cooling medium can be adjusted as desired or as required. This provides numerous advantageous customization options. The hole structure allows the medium to flow directly past the cell walls 18a and dissipate heat,

FIG. 6 shows a schematic illustration of a battery module 16 according to an exemplary embodiment of the invention. The battery module 16 comprises a cell stack 14 with a plurality of prismatic battery cells 18 arranged adjacent to one another in a stacking direction S. The cell sides facing one another are designated 18a in the present case. An inter-cell cooling unit 10 is arranged between each two adjacent cells 18. In this example, a respective inter-cell cooling unit 10 consists only of the base element 12. In other words, the inter-cell cooling unit 10 in this example has no regions that protrude from the intermediate space 20 between two adjacent cells 18. The individual cooling channels 36 described above are open at their ends with respect to the x-direction shown here. In this example, the battery module 16 has a cooling device 38 which provides an open flow of the cooling medium 40 around the cells 18. For this purpose, the battery module has a fluid-tight receptacle 42 in which the cell stack 14 is arranged. The receptacle 42 can have a supply connection 44 for supplying the coolant 40 and a discharge connection 46 for discharging the coolant 40 from the receptacle 42, in particular after flowing through the intermediate spaces 20 between the cells 18 and in particular after flowing through the inter-cell cooling units 10 arranged in the intermediate spaces 20. The arrows 40′ illustrate the coolant 40 flowing through the cooling channels 36 of the inter-cell cooling units 10. Within the receptacle 42, the coolant 40 can therefore move essentially freely. It can therefore also come into contact with sides of the cells 18 on which the inter-cell cooling units 10 are not arranged. In this case, the cell pack 14 is located directly in the fluid 40. Due to a pressure difference between supply flow and return flow, i.e. between the supply connection 44 and the discharge connection 46, the fluid 40 flows between the cells 18 through the inter-cell cooling units 10.

Alternatively, each inter-cell cooling unit 10 can be provided with a nozzle for such a supply and return flow, as shown schematically in FIG. 7.

FIG. 7 shows a schematic representation of an inter-cell cooling unit 10 according to a further exemplary embodiment of the invention. It can be designed as described above, except for the differences described below. This again comprises a base element 12 and, in addition to this base element 12, connection regions 22a, 22b. Each of these connection regions 22a, 22b can be formed with a nozzle 50, 52. A coolant 40 can be supplied to the inter-cell cooling unit 10 and discharged therefrom again via these nozzles 50, 52. For example, the coolant can be supplied via the first nozzle 50 and discharged again via the second nozzle 52 after passing through the base element 12 or the cooling channels 36 integrated therein. In order to ensure in particular that despite the hole pattern 30′ no coolant 40 can leak, a seal 54 is provided therefor. It completely encircles the region of the base element 12 with the hole pattern 30′. The seal 54 can therefore be designed to be closed all the way around, directly adjacent to the edge 56 of the base element 12. The seal 54 then rests accordingly on the corresponding cell side 18a of an adjacent cell 18 when the inter-cell cooling unit 10 is arranged as intended in the cell stack 14. The connection regions 22a, 22b then protrude, for example, in and against the x-direction from the intermediate space 20 between the cells 18. This facilitates the connection of a coolant supply and discharge line to the respective nozzles 50, 52. For example, the supply nozzles 50 of several inter-cell cooling units 10 can be supplied with coolant 40 via a common supply line and the coolant 40 which has flowed through the respective inter-cell cooling units 10 can also be discharged via a common discharge line to which the respective discharge nozzles 52 are connected.

The base element 12, in particular the cooling walls 24, 26, are also designed in this example with a slightly different hole pattern 30′. In this example, the openings 30 are not limited to regions that do not contact the intermediate wall 34. This hole pattern, in particular with openings 30 offset from one another, makes it possible to provide a particularly large passage region. A circular opening 30 is surrounded by six circular openings of equal size 30′ according to this hole pattern. This applies to each of the openings 30, except those in the peripheral region.

Overall, the examples show how the invention can provide inter-cell cooling in the form of a sandwich plate with perforated outer plates. By combining a corrugated sheet structure with two perforated outer plates as spacers between prismatic cells, both the circulation of the cooling medium and the absorption of swelling forces can be ensured. By drilling holes in the two outer plates, a very good thermal connection of the cooling fluid to the cells can be ensured. The hole structure allows the medium to flow directly past the cell walls and dissipate heat.

1. An inter-cell cooling unit for arrangement in an intermediate space between two battery cells of a cell stack which are arranged adjacent to one another in a stacking direction,
wherein the inter-cell cooling unit has two cooling walls comprising a first cooling wall for arrangement on a first of the two battery cells and a second cooling wall for arrangement on a second of the two battery cells, and
wherein at least one free space through which a coolant can flow is formed between the first and second cooling walls,
wherein at least one first opening is arranged in at least one of the two cooling walls, through which first opening a fluidic connection is provided between the at least one free space and an environment of the inter-cell cooling unit.

2. The inter-cell cooling unit according to claim 1, wherein in the first cooling wall, the at least one first opening is arranged and in the second cooling wall, at least one second opening is arranged, through which a respective fluidic connection between the at least one free space and an environment of the inter-cell cooling unit is provided.

3. The inter-cell cooling unit according to claim 1, wherein the inter-cell cooling unit has a structural element, in particular an intermediate wall with a corrugated structure, which is arranged between the first and the second cooling wall and which divides the free space between the first and the second cooling wall into multiple partial free spaces.

4. The inter-cell cooling unit according to claim 1, wherein the intermediate wall has at least one third opening through which at least two of the partial free spaces are fluidically connected to one another.

5. The inter-cell cooling unit according to claim 1, wherein at least in the first cooling wall, a hole pattern enclosing the first opening with several first openings is arranged.

6. The inter-cell cooling unit according to claim 1, wherein the first openings are geometrically identical, in particular wherein the hole pattern is designed as a regular pattern.

7. The inter-cell cooling unit according to claim 1, wherein the hole pattern comprises at least two first openings, which differ in size, and of which
one is located in a peripheral region of the first cooling wall and the other in a central region of the first cooling wall; and
one is located in a hotspot region of the battery cell adjacent to the first cooling wall when the inter-cell cooling unit is arranged as intended between the two battery cells, and the other in a cell region which is different from a hotspot region.

8. A battery module for a motor vehicle, with a cell stack, which comprises at least two battery cells arranged adjacent to one another in a stacking direction, and with an inter-cell cooling unit according claim 1, which is arranged between the two battery cells.

9. The battery module according to claim 8, wherein the partial free spaces provide respective cooling channels, which run from one channel input to one channel output, wherein the inter-cell cooling unit has a first connection element, which is connected to the respective channel inputs and through which a coolant can be supplied to the inter-cell cooling unit and a second connection element, which is connected to the channel outlets and through which the coolant is dischargeable from the inter-cell cooling unit, wherein the region of the first cooling wall, which comprises the at least one first opening, in particular the first hole pattern, is arranged at the first battery cell, on which the first cooling wall is arranged, while being sealed against it by a seal encircling the region of the first cooling wall.

10. The battery module according to claim 8, wherein the battery module has a cooling device which comprises the inter-cell cooling unit, wherein the inlets and outlets of the respective cooling channels are fluidically connected to an environment of the battery module, wherein the cooling device is designed such that the battery cells are at least partially in contact with a coolant located outside the inter-cell cooling element during operation of the cooling device.

11. The inter-cell cooling unit according to claim 2, wherein the inter-cell cooling unit has a structural element, in particular an intermediate wall with a corrugated structure, which is arranged between the first and the second cooling wall and which divides the free space between the first and the second cooling wall into multiple partial free spaces.

12. The inter-cell cooling unit according to claim 2, wherein the intermediate wall has at least one third opening through which at least two of the partial free spaces are fluidically connected to one another.

13. The inter-cell cooling unit according to claim 3, wherein the intermediate wall has at least one third opening through which at least two of the partial free spaces are fluidically connected to one another.

14. The inter-cell cooling unit according to claim 2, wherein at least in the first cooling wall, a hole pattern enclosing the first opening with several first openings is arranged.

15. The inter-cell cooling unit according to claim 3, wherein at least in the first cooling wall, a hole pattern enclosing the first opening with several first openings is arranged.

16. The inter-cell cooling unit according to claim 4, wherein at least in the first cooling wall, a hole pattern enclosing the first opening with several first openings is arranged.

17. The inter-cell cooling unit according to claim 2, wherein the first openings are geometrically identical, in particular wherein the hole pattern is designed as a regular pattern.

18. The inter-cell cooling unit according to claim 3, wherein the first openings are geometrically identical, in particular wherein the hole pattern is designed as a regular pattern.

19. The inter-cell cooling unit according to claim 4, wherein the first openings are geometrically identical, in particular wherein the hole pattern is designed as a regular pattern.

20. The inter-cell cooling unit according to claim 5, wherein the first openings are geometrically identical, in particular wherein the hole pattern is designed as a regular pattern.
